(19) United States
(12) Patent Application Publication
(10) Pub. No.: US 2007/0071016 A1
(43) Pub. Date: Mar. 29, 2007

(54) Communicating station-originated data to a target access point via a distribution system

(75) Inventor: Emek Sadot, Ocean, NJ (US)

Correspondence Address: DEMONT & BREYER, LLC, 100 COMMONS WAY, STE 250, HOLMDEL, NJ, 07733, US

(73) Assignee: Avaya Technology Corp., Basking Ridge, NJ (US)

(21) Appl. No.: 11/238,924

(22) Filed: Sep. 29, 2005

(51) Int. Cl. H04L 12/56

(52) U.S. Cl. 370/401

(57) ABSTRACT

A method and an apparatus are disclosed that mitigate congestion in a backbone network that is associated with a wireless network. The illustrative embodiment of the present invention mitigates the congestion by reducing the occurrences of a bridge data-processing system flooding out pre-authentication-related packets, as well as some other types of packets, on multiple ports of the bridge. In particular, each access point initially advertises its wireless network MAC address to the backbone network, in accordance with the illustrative embodiment, in addition to advertising its backbone network MAC address. Doing so enables each bridge in the backbone network to learn and recognize the wireless network MAC address, which results in the bridge directing the pre-authentication packet to a specific port that corresponds to the target access point.

### FIELD OF THE INVENTION

The present invention relates to telecommunications in general, and, more particularly, to coordinating packet data transmissions from a telecommunications station to a target access point via the distribution system associated with a wireless local area network.

### BACKGROUND OF THE INVENTION

FIG. 1 depicts a block diagram of telecommunications system 100 in the prior art. System 100 comprises bridges 111-1 through 111-M, wherein M is a positive integer; access points 122-1 through 122-N, wherein N is a positive integer greater than one; and station 121, interrelated as shown. System 100 comprises a wireless network, itself comprising wireless station 121 and access points 122-1 through 122-N. System 100 further comprises a backbone network that is part of a distribution system, wherein the backbone network comprises bridges 111-1 through 111-M. The distribution system supports the mobility of stations, such as station 121, by connecting access points 122-1 through 122-N.

Station 121 is a wireless telecommunications data-processing system, such as a personal computer (PC) with a wireless network interface card, a wireless local area network telephone, and so forth. Station 121 comprises a radio that enables the station to communicate wirelessly via a set of communications rules known as the Institute of Electrical and Electronics Engineers (IEEE) 802.11 wireless local area network (WLAN) set of protocols. Station 121 uses the IEEE 802.11 set of protocols to communicate with one or more nodes (e.g., other stations, access points, servers, etc.) through an access point, such as access point 122-2.

Access point 122-n, wherein n has a value of between 1 and N, inclusive, comprises (i) a radio interface to the wireless network in which station 121 operates, (ii) an interface to the backbone network, and (iii) bridging functionality that supports communications between the wireless network and backbone network. Together, the backbone network and the bridging functionality make up the distribution system. The access point acts as a base station for the wireless network, aggregating access for multiple wireless stations (e.g., station 121, etc.) onto the distribution system. Access point 122-n communicates with stations in the wireless network via the IEEE 802.11 set of protocols and communicates with other nodes through the backbone network via another set of protocols, such as IEEE 802.3 or “Ethernet.”

Bridge 111-m, wherein m has a value of between 1 and M, inclusive, comprises (i) two or more interfaces to other nodes, such as access points, other bridges, stations, and servers, and (ii) bridging software that supports communications between the different interfaces. Bridge 111-m communicatively connects two or more access points 122-1 through 122-N together through hardware ports on the bridge data-processing system. In some operational scenarios, a single bridge might be used to connect two or more access points. In other scenarios, such as one that is depicted in FIG. 1, two or more bridges might be situated between two access points to provide connectivity between the access points. For example, in FIG. 1 the signal path between access point 122-2 and access point 122-3 passes through bridges 111-3 and 111-4. If station 121 needs to communicate with access point 122-3 but is currently within transmitting range of access point 122-2, station 121 transmits a packet, or “bundle,” of data to access point 122-2, which then transmits the packet to bridge 111-3. (In some applications, a packet is referred to as a “frame.”) Bridge 111-3, in sequence, forwards the packet to bridge 111-4, which then forwards the packet to access point 122-3.

In telecommunications system 100, station 121 and access points 122-1 through 122-M are each assigned a media access control address, or “MAC” address, to identify the data-processing system. In fact, each of access points 122-1 through 122-M has two MAC addresses: a wireless network MAC address for its wireless network side and a backbone network MAC address for its backbone network side. Note that it is possible for an access point in the prior art to have more than one wireless network MAC address, one for each of the access point's virtual wireless networks on its wireless network side.

To make traffic forwarding decisions, bridge 111-m uses the MAC address information contained in each packet. Each packet that is transmitted from one point to another typically contains a source MAC address that identifies the sender and a destination MAC address that identifies the recipient of the packet. Bridge 111-m learns which of its hardware ports have which nodes attached to the bridge by monitoring and recording the source MAC address of packets that arrive at the bridge. Bridge 111-m examines the destination MAC address and compares it to a list of recorded, or “learned,” addresses to determine on which port to send the packet. If bridge 111-m has not yet learned a destination MAC address of a particular packet, bridge 111-m floods the packet out of every port to ensure that the unknown recipient receives the packet.

When station 121 initially indicates to an access point that it wishes to communicate, station 121 has to authenticate and then associate with the access point of interest. Through authentication, station 121 proves to the access point that the station is what it claims to be. Once authenticated, station 121 may then associate itself with the access point for the purposes of transmitting and receiving packets.

Station 121, which as depicted in FIG. 1 is being presently associated with access point 122-2, is capable of mobility; therefore, it can move, for example, from the wireless coverage area supported by access point 122-2 to the wireless coverage area supported by access point 122-3. As station 121 moves closer to access point 122-3, station 121 once again has to authenticate and then associate, this time with access point 122-3. To speed up the process, however, station 121 is allowed to authenticate with access point 122-3 by communicating through access point 122-2; this procedure is referred to as pre-authentication. The distribution system of system 100—as stated earlier comprising (i) the bridging functionality in access points 122-1 through 122-N and (ii) the backbone network—enables the pre-authentication information to make its way from station 121 to access point 122-2 and subsequently to access point 122-3. The faster pre-authentication mechanism, which is specified in the IEEE 802.11i set of protocols, is particularly important when station 121 is transmitting or receiving a stream of delay-sensitive packets, such as packets that convey voice traffic. In transmitting these packets, a long enough delay in re-associating with target access point 122-3 would create an unacceptable gap in the packet stream.

### SUMMARY OF THE INVENTION

The problem with pre-authentication in the prior art is that in transmitting the pre-authentication packet to the access point with which a station is associated, the station has to specify the wireless network MAC address of the target access point. After all, the station has no knowledge of the target access point's backbone network MAC. At the same time, the bridges in the backbone network have no knowledge of the target access point's wireless network MAC address because the target access point advertises, to the bridges, only its backbone network MAC address as its source address. Consequently, every time a bridge receives a pre-authentication packet, the bridge will flood the packet out on all ports in use, causing all bridges in the backbone network to flood the packet out on their ports, thereby increasing traffic congestion in the backbone network. Furthermore, the congestion may worsen over time as delay-sensitive applications that rely on pre-authentication, such as the streaming of voice traffic packets, occupy an increasing share of resources in the backbone network.

The present invention provides a technique to mitigate congestion in the backbone network by reducing the occurrences of a bridge flooding out pre-authentication packets on multiple ports. In particular, each access point initially advertises its wireless network MAC address—or addresses, if the access point has more than one—to the backbone network, in accordance with the illustrative embodiment, in addition to advertising its backbone network MAC address. Doing so enables each bridge in the backbone network to learn and recognize the one or more wireless network MAC addresses; this results in the bridge directing the pre-authentication packet to a specific port that corresponds to the target access point.

In accordance with the illustrative embodiment of the present invention, each wireless network MAC address is transmitted as a source address in the backbone network during certain conditions. For example, if the access point powers up or restarts, it advertises its one or more wireless network MAC addresses by transmitting a packet—one for each address—that represents the address as a source address. In some embodiments, during its ongoing operation if the access point does not detect an occasional use in the backbone network of the wireless network MAC address as a destination address, the access point will re-transmit each address as a source address. The re-transmitting deals with the issue of some bridges allowing learned addresses to lapse after a certain interval of not having detected the address.

Before the pre-authentication procedure existed, there was little reason, if any, to advertise a wireless network MAC address in the backbone network, just as there was little reason to advertise a backbone network MAC address in the wireless network. The illustrative embodiment recognizes that in some emerging applications, a MAC address from a first link-layer network is not only meaningful in a second link-layer network, but that utilizing that MAC address in that second network can be beneficial in terms of operating performance.

For pedagogical purposes, the IEEE 802.11 pre-authentication procedure is featured in the illustrative embodiment. As those who are skilled in the art will appreciate, however, the present invention is applicable to other procedures that use an address from one network for addressing a node in another network. For example, the present invention is applicable to the IEEE 802.11r procedure of over-the-distribution-system pre-reservation. Those who are skilled in the art will also appreciate that the present invention is applicable to wireless networks other than IEEE 802.11-based networks and to backbone networks other than Ethernet-based networks. Finally, those who are skilled in the art will appreciate that the present invention is applicable to networks that use addressing other than media access control-based addressing.

The illustrative embodiment of the present invention comprises: a first network interface for transmitting a first media access control address and a second media access control address in a first network; a second network interface for transmitting the second media access control address in a second network, wherein the second network interface refrains from transmitting the first media access control address in the second network; and a processor for bridging the first network and the second network.

### BRIEF DESCRIPTION OF THE DRAWINGS

FIG. 1 depicts a block diagram of telecommunications system 100 in the prior art.

FIG. 2 depicts a block diagram of telecommunications system 200, in accordance with the illustrative embodiment of the present invention.

FIG. 3 depicts a block diagram of the salient components of access point 222-n in accordance with the illustrative embodiment of the present invention.

FIG. 4 depicts a flowchart of the operation of access point 222-n, in accordance with the illustrative embodiment of the present invention.

FIG. 5 depicts a message flow diagram related to telecommunications system 200, in accordance with the illustrative embodiment of the present invention.

### DETAILED DESCRIPTION

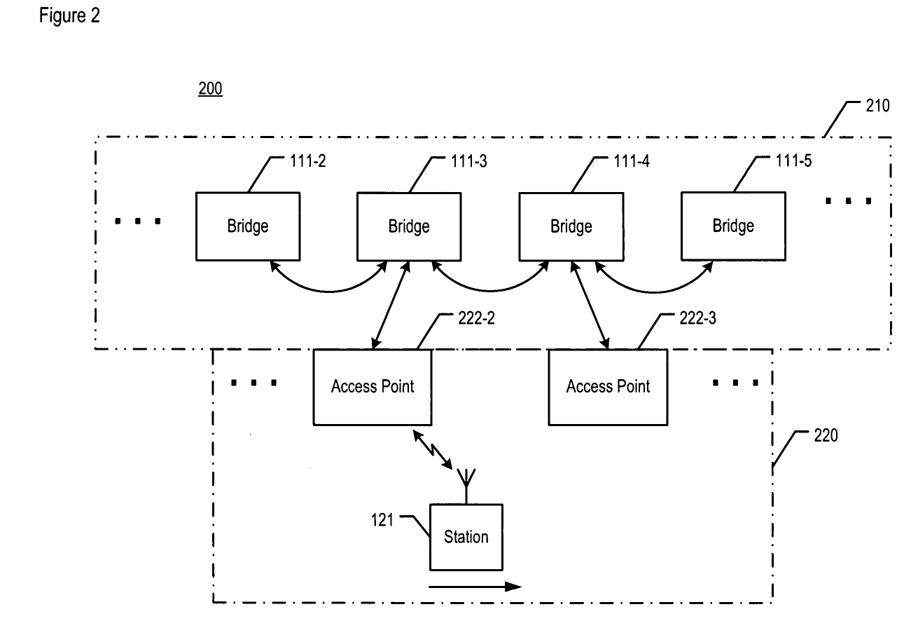

FIG. 2 depicts a block diagram of telecommunications system 200, in accordance with the illustrative embodiment of the present invention. System 200 comprises bridges 111-1 through 111-M, wherein M is a positive integer; access points 222-1 through 222-N, wherein N is a positive integer greater than one; and station 121, interrelated as shown. System 200 comprises wireless network 220, itself comprising wireless station 121 and access points 222-1 through 222-N. System 200 further comprises backbone network 210 that is part of a distribution system, wherein backbone network 210 comprises bridges 111-1 through 111-M. The distribution system supports the mobility of stations, such as station 121, by connecting access points 222-1 through 222-N.

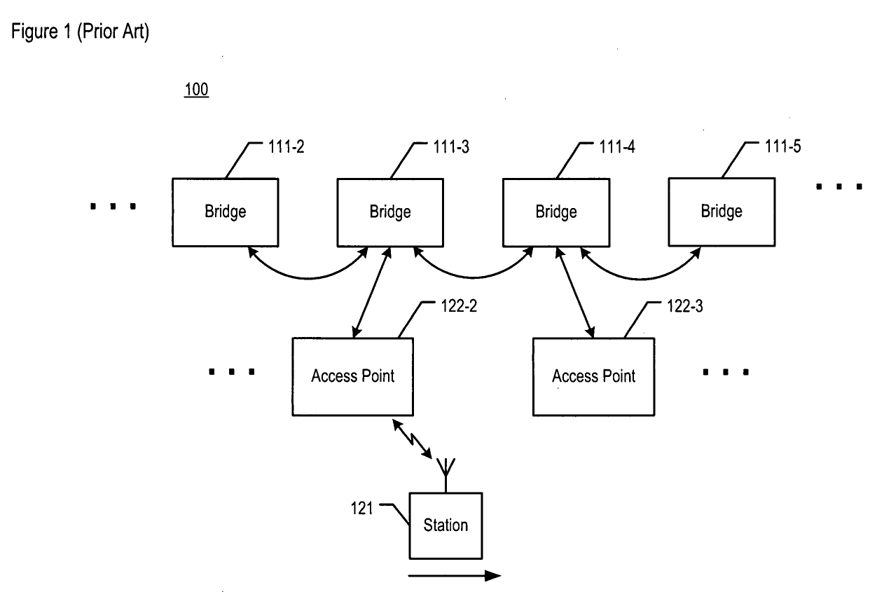

Station 121 and bridge 111-m, wherein m has a value of between 1 and M, were described earlier and with respect to FIG. 1. Although bridge data-processing systems are featured in the illustrative embodiment, it will be clear to those skilled in the art how to make and use system 200 with other data-processing systems that are capable of bridging, such as layer two switches. It will be clear to those skilled in the art how to make and use station 121 and bridge 111-m.

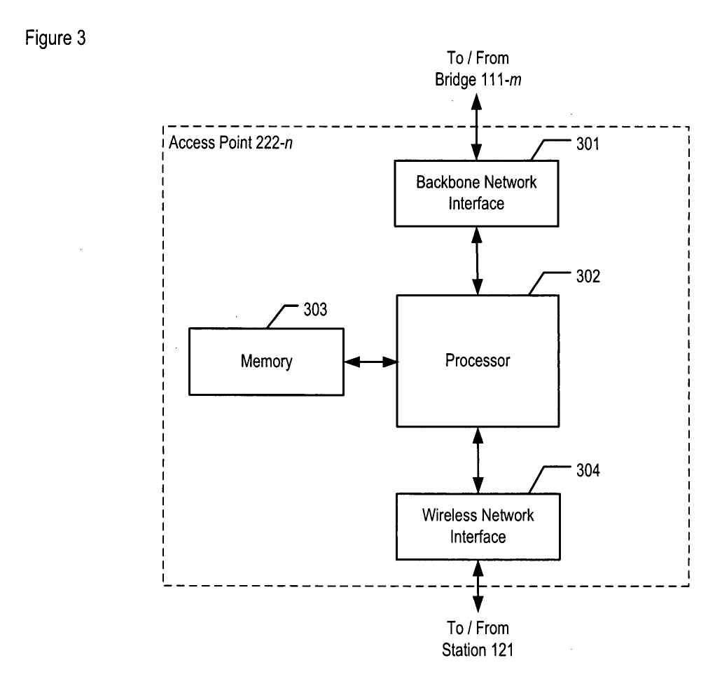

Access point 222-n, wherein n has a value of between 1 and N, inclusive, comprises (i) a radio interface to the wireless network to which station 121 belongs, (ii) an interface to the backbone network, and (iii) bridging functionality that supports communications between wireless network 220 and backbone network 210. The access point, the salient components of which are described below and with respect to FIG. 3, acts as a base station for the wireless network, aggregating access for multiple wireless stations (e.g., station 121, etc.) onto the distribution system. Access point 222-n communicates with stations in the wireless network via the IEEE 802.11 set of protocols and communicates with other nodes through the backbone network via another set of protocols, such as IEEE 802.3 or “Ethernet.”

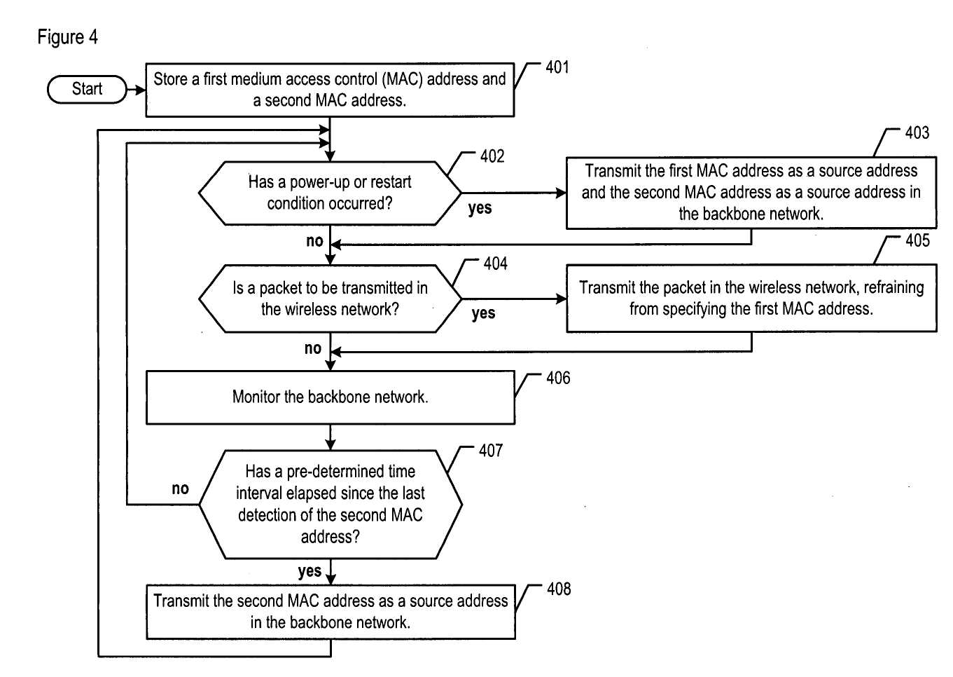

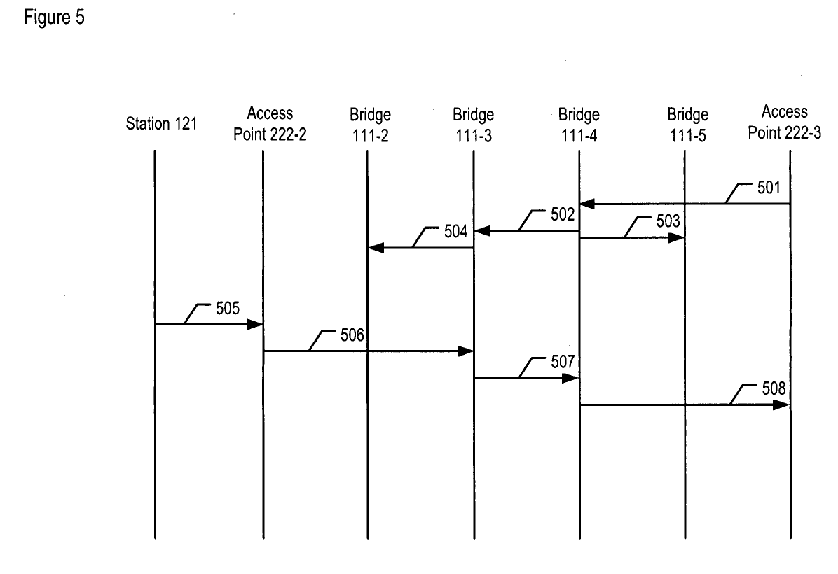

Moreover, access point 222-n is capable of performing the tasks described below and with respect to FIGS. 4 and 5, in accordance with the illustrative embodiment of the present invention. It will be clear to those skilled in the art, after reading this specification, how to make and use access point 222-n.

For pedagogical purposes, the illustrative embodiment of the present invention is taught with access point 222-n having two MAC addresses: a wireless network MAC address for its wireless network side and a backbone network MAC address for its backbone network side. As those who are skilled in the art will appreciate, the present invention is also applicable to where an access point has more than one wireless network MAC address, one for each of the access point's virtual wireless networks on its wireless network side.

As those who are skilled in the art will recognize, there has been a shift in wireless local area network architectures from autonomous access points to “light weight access points” with centralized control (i.e., the IETF CAPWAP protocol, as is known in the art). One goal has been to move most of the traditional wireless functionality such as access control (including user authentication and authorization), mobility, and radio management, as well as the distribution system functionality, out of the access point into a centralized controller, referred to as an “access controller.” Although the illustrative embodiment of the present invention features an access point, as those who are skilled in the art will appreciate the present invention is equally applicable to telecommunications systems that comprise light weight access points (also known as “wireless termination points”) and access controllers.

FIG. 3 depicts a block diagram of the salient components of access point 222-n in accordance with the illustrative embodiment of the present invention. Access point 222-n comprises backbone network interface 301, processor 302, memory 303, and wireless network interface 304, interconnected as shown.

Backbone network interface 301 comprises a receiving part and a transmitting part. The receiving part receives packet-related signals from the distribution system medium that is network 210 and forwards the information encoded in the signals to processor 302, in well-known fashion. The transmitting part receives information from processor 302, and outputs packet-related signals that encode this information to the distribution system medium in network 210, in well-known fashion. It will be clear to those skilled in the art, after reading this specification, how to make and use backbone network interface 301.

Processor 302 is a general-purpose processor that is capable of receiving information from backbone network interface 301 and wireless network interface 304; reading data from and writing data into memory 303; executing the tasks described below and with respect to FIGS. 4 and 5; and transmitting information to backbone network interface 301 and wireless network interface 304. Processor 302 also provides at least a part of the bridging functionality that bridges networks 210 and 220. In some alternative embodiments of the present invention, processor 302 might be a special-purpose processor. In either case, it will be clear to those skilled in the art, after reading this disclosure, how to make and use processor 302.

Memory 303 stores data and executable instructions, in well-known fashion. It will be clear to those skilled in the art how to make and use memory 303.

Wireless network interface 304 comprises a receiving part and a transmitting part. The receiving part receives packet-related signals from the wireless medium in wireless network 220 and forwards the information encoded in the signals to processor 302, in well-known fashion. The transmitting part receives information from processor 302, and outputs packet-related signals that encode this information to the wireless medium in network 220, in well-known fashion. It will be clear to those skilled in the art how to make and use wireless network interface 304.

FIG. 4 depicts a flowchart of the operation of access point 222-n, in accordance with the illustrative embodiment of the present invention. Access point 222-n, as depicted, determines when to transmit its wireless network address as a source address in the backbone network, in accordance with the illustrative embodiment of the present invention. It will be clear to those skilled in the art which tasks depicted in FIG. 4 can be performed simultaneously or in a different order than that depicted.

At task 401, access point 222-n stores a first media access control (MAC) address and a second media access control address in well-known fashion. The first MAC address is used in network 210—and not necessarily in network 220—as a first identifier of access point 222-n. The second MAC address is used by station 121 during the pre-authentication procedure and, as a result, in network 210 as a second identifier of access point 222-n in that network. The second MAC address is also used in network 220 as an identifier of access point 222-n.

At task 402, access point 222-n determines, in well-known fashion, if it has been booted, by having been powered up or restarted. If it has, task execution proceeds to task 403. If not, task execution proceeds to task 404.

At task 403, access point 222-n transmits, into the backbone network, the first MAC address and the second MAC address as its source addresses, in accordance with the illustrative embodiment of the present invention.

At task 404, access point 222-n determines if there is a packet to be transmitted in network 220. For example, the access point might need to transmit a data frame to station 121 or to broadcast a management frame to multiple stations. If so, task execution proceeds to task 405. If not, task execution proceeds to task 406.

At task 405, access point 222-n transmits the packet in network 220. Note that in some embodiments, the access point always refrains from transmitting any packets in network 220 with the first MAC address specified.

At task 406, access point 222-n monitors the distribution system medium in network 210 in well-known fashion for a packet that uses the second MAC address as a destination address.

At task 407, access point 222-n determines if a pre-determined time interval has elapsed since the latest detection of the second MAC address having been used as a destination address in network 210. In some embodiments, the value of the time interval is based on the behavior of one or more of bridges 111-1 through 111-M. For example, if a bridge is designed to clear an address from its MAC address table if it does not detect the address being used within a time limit, the value of access point 222-n's time interval can be based on the bridge's time limit. If the interval has elapsed, task execution proceeds to task 408. If not, task execution proceeds to task 402.

At task 408, access point 222-n transmits, in network 210, the second MAC address as its source address in accordance with the illustrative embodiment of the present invention. Task execution then proceeds to task 402.

FIG. 5 depicts a message flow diagram related to telecommunications system 200, in accordance with the illustrative embodiment of the present invention. The message flow diagram illustrates a sequence in which access point 222-3 first powers up and station 121 subsequently preauthenticates to access point 222-3 via access point 222-2.

Via message 501, upon powering up, access point 222-3 transmits its second MAC address (i.e., its wireless network identifier) in backbone network 210.

Bridge 111-4 receives the transmission from access point 222-3 and floods the received packet, as a broadcast message (i.e., messages 502 and 503), through all of its ports to the other connected bridges, namely bridges 111-3 and 111-5.

Bridge 111-3 receives the transmission from bridge 111-4. Via message 504, bridge 111-3 forwards the received address to the other connected bridges, including bridge 111-2.

During this process, bridges 111-1 through 111-M in backbone network 210 learn whatever source MAC addresses they receive, in well-known fashion. In accordance with the illustrative embodiment, access point 222-3 has transmitted its wireless network MAC address as a source address and, as a result, bridges 111-1 through 111-M are made aware of and learn access point 222-3's wireless network MAC address, an address that the bridges were unable to learn in the prior art.

During the ongoing operation of telecommunications system 200, when station 121, which is presently associated with access point 222-2, wishes to preauthenticate to access point 222-3, the station transmits a pre-authentication-related packet to access point 222-2 via message 505 in well-known fashion. In the packet, station 121 specifies the only MAC address of access point 222-2 that station 121 is aware of, namely the wireless network MAC address.

Via message 506, access point 222-2 constructs and transmits a pre-authentication-related packet to bridge 111-3, which comprises the wireless network MAC address.

Bridge 111-3, having previously learned and now recognizing the wireless network MAC address of access point 222-3, forwards the packet only to bridge 111-4 via message 507.

Bridge 111-4, also having previously learned and now recognizing the wireless network MAC address of access point 222-3, forwards the packet only to access point 222-3 via message 508.

It is to be understood that the above-described embodiments are merely illustrative of the present invention and that many variations of the above-described embodiments can be devised by those skilled in the art without departing from the scope of the invention. For example, in this Specification, numerous specific details are provided in order to provide a thorough description and understanding of the illustrative embodiments of the present invention. Those skilled in the art will recognize, however, that the invention can be practiced without one or more of those details, or with other methods, materials, components, etc.

Furthermore, in some instances, well-known structures, materials, or operations are not shown or described in detail to avoid obscuring aspects of the illustrative embodiments. It is understood that the various embodiments shown in the Figures are illustrative, and are not necessarily drawn to scale. Reference throughout the specification to “one embodiment” or “an embodiment” or “some embodiments” means that a particular feature, structure, material, or characteristic described in connection with the embodiment(s) is included in at least one embodiment of the present invention, but not necessarily all embodiments. Consequently, the appearances of the phrase “in one embodiment,” “in an embodiment,” or “in some embodiments” in various places throughout the Specification are not necessarily all referring to the same embodiment. Furthermore, the particular features, structures, materials, or characteristics can be combined in any suitable manner in one or more embodiments. It is therefore intended that such variations be included within the scope of the following claims and their equivalents.

What is claimed is:

1. An apparatus comprising:
a first network interface for transmitting a first media access control address and a second media access control address in a first network;
a second network interface for transmitting said second media access control address in a second network, wherein said second network interface refrains from transmitting said first media access control address in said second network; and
a processor for bridging said first network and said second network.

2. The apparatus of claim 1 wherein said first network interface is also for receiving an application-layer datum from said second network interface and for transmitting said application-layer datum in said first network.

3. The apparatus of claim 1 wherein said apparatus is an IEEE 802.11 access point, wherein the media access control of said first network is based on a set of protocols other than IEEE 802.11, and wherein the media access control of said second network is IEEE 802.11-based.

4. The apparatus of claim 1 wherein said first network interface transmits said second media access control address as a source address of said apparatus.

5. The apparatus of claim 4 wherein said first network interface is also for receiving a boot indication, wherein the transmitting of said second media access control address by said first network interface is as the result of receiving said boot indication.

6. The apparatus of claim 4 wherein said first network interface is also for monitoring said first network;
wherein the transmitting of said second media access control address by said first network interface is as the result of having failed to detect said second media access control address as a destination address in said first network within a predetermined time interval.

7. The apparatus of claim 1 further comprising a data-processing system for:
(i) storing said second media access control address, and
(ii) forwarding said second media access control address;
wherein said data-processing system exists in said first network, but not in said second network.

8. The apparatus of claim 7 wherein said first network interface and said second network interface constitute an access point, and wherein said data-processing system is one of (i) a bridge and (ii) a layer two switch.

9. A method comprising:
transmitting a first media access control address and a second media access control address in a first network; and
transmitting said second media access control address, but not said first media access control address, in a second network.

10. The method of claim 9 further comprising:
receiving an application-layer datum from said second network; and
transmitting said application-layer datum in said first network.

11. The method of claim 9 wherein the transmission of said second media access control address (i) in said first network is in accordance with a set of protocols other than IEEE 802.11 and (ii) in second network is in accordance with an IEEE 802.11-based set of protocols.

12. The method of claim 9 wherein said second media access control address is transmitted in said first network as a source address.

13. The method of claim 12 further comprising receiving a boot indication, wherein the transmission of said second media access control address in said first network is as the result of receiving said boot indication.

14. The method of claim 13 wherein said boot indication is based on a power-up condition.

15. The method of claim 13 wherein said boot indication is based on a restart condition.

16. The method of claim 12 further comprising monitoring said first network, wherein the transmission of said second media access control address in said first network is as the result of having failed to detect said second media access control address as a destination address in said first network within a predetermined time interval.

17. The method of claim 9 further comprising:
storing, at a data-processing system, said second media access control address; and
forwarding, from said data-processing system, said second media access control address;
wherein said data-processing system exists in said first network but not in said second network.

18. The method of claim 17 wherein said data-processing system is one of (i) a bridge and (ii) a layer two switch.

19. A system comprising:
an access point for (i) transmitting a first media access control address and a second media access control address in a first network and (ii) transmitting said second media access control address, but not said first media access control address, in a second network; and
a data-processing system for receiving said first media access control address and said second media access control address in said first network wherein said first data-processing system does not exist in said second network.

20. The system of claim 19 wherein said access point is also for receiving an application-layer datum from said second network and for transmitting said application-layer datum in said first network.

21. The system of claim 19 wherein said access point operates in accordance with an IEEE 802.11-based set of protocols, wherein the media access control of said first network is based on a set of protocols other than IEEE 802.11, and wherein the media access control of said second network is IEEE 802.11-based.

22. The system of claim 19 wherein said access point transmits said second media access control address as a source address of said access point in said first network.

23. The system of claim 22 wherein the transmitting of said second media access control address in said first network is as the result of one of (i) a power-up condition and (ii) a restart condition.

24. The system of claim 22 wherein said access point is also for monitoring said first network;
wherein the transmitting of said second media access control address in said first network is as the result of having failed to detect said second media access control address as a destination address in said first network within a predetermined time interval.

25. The system of claim 19 wherein said data-processing system is one of (i) a bridge and (ii) a layer two switch.

26. The system of claim 19 wherein said data-processing system comprises a first port and a second port, and wherein said data-processing system is also for selecting, based on said second media access control address, one of said first port and said second port on which to transmit a datum.
